(19) United States
(12) Patent Application Publication
(10) Pub. No.: US 2020/0070377 A1
(43) Pub. Date: Mar. 5, 2020

(54) FOOD SLICER

(71) Applicants: José Manuel JAUREGUIBEITIA OLALDE, Azuaga (ES); ERQUS & QUERCIA, S.L., Azuaga (ES)

(72) Inventor: José Manuel JAUREGUIBEITIA OLALDE, Azuaga (ES)

(21) Appl. No.: 16/613,622

(22) PCT Filed: May 15, 2017
(86) PCT No.: PCT/ES2017/070311

§ 371 Date: Nov. 14, 2019

(51) Int. Cl. B26D 1/00; B26D 1/18; B26D 7/06

(52) U.S. Cl. CPC B26D 1/0006; B26D 1/18; B26D 2210/02; B26D 2001/0053; B26D 7/0616

(57) ABSTRACT

The food slicer comprises a first support module for supporting at least one slicing blade, a second support module for supporting at least one piece of food and a drive mechanism means for transforming a relative movement of the first and second support modules into a movement of the slicing blade in the first support module, said relative movement involving a change in the height (h) between the first and second support modules. The slicing blade has a protruding portion protruding from at least one surface of the slicing blade in accordance with at least one ramp oriented to facilitate separation of the sliced piece of food from the rest of the piece of food without damaging it.

The present disclosure relates to a slicer for slicing foods such as, for example, ham. The present food slicer can, however, be generally used to slice a wide variety of foods, such as cold meats, sausages, and the like.

### BACKGROUND

Products are usually distributed by food industry to distributors and retailers, for example ham, cold meats, sausages, etc., in whole pieces or in parts sliced to a suitable size. If products are distributed in whole pieces, without being sliced, they sometimes have to be sliced by the distributor or retailer so that they are properly supplied to the customer. The end user faces the tedious difficulty of having to slice products that were acquired in a single piece. In this case, machines for slicing foods, such as ham, are used, comprising a rotating circular blade. The rotating blade is driven either by motor means or manually.

One example of the driving of the slicing blade by motor means is disclosed in patent U.S. Pat. No. 4,246,821. This document discloses a food slicing machine comprising a slicing blade driven in rotation by a motor and a mechanism for adjusting the thickness of the slice comprising a plate that can be moved by a knob.

Provision of a motor driven slicing blade has the drawback that the speed of rotation of the blade can not be adjusted precisely to adapt to each particular product. While a blade rotation speed may be appropriate for one type of food to be sliced, that same blade rotation speed may adversely affect the properties of another food. In many products, especially in foods such as ham and the like, an inappropriately high slicing blade rotation speed may cause excessive heating of the product to be sliced, which may substantially alter its organoleptic and taste characteristics, adversely affecting the product to be consumed. Another drawback is that part of the food slice may be carried by the slicing blade, when rotated, and pushed it into an improper position, making it difficult to exit, or causing it to be split, or causing some fats of the food to be melted by heating. This is a serious drawback for the end consumer.

In order to at least reduce this problem, slicing machines have been proposed for slicing pieces of food in which the slicing blade is driven in rotation by manually varying the relative position between it and the food to be sliced. One example of manual actuation of the blade is described in the utility model ES1128030, that relates to a machine for slicing pieces of ham and the like where a blade is rotated manually operated by the user. For this purpose, drive means are provided for converting a manual movement of a horizontal travel sliding platform on which the piece of food to be sliced is arranged, into a rotating movement of the slicing blade.

As the horizontal travel sliding platform is pushed by the user, the blade is rotated according to a predetermined speed, set by said drive means.

The machine disclosed in this utility model has in many cases been shown to be satisfactory since said drive means provide the slicing blade a rotational speed suitable for slicing the food without damaging it. However, it has been found that the arrangement of a sliding platform in combination with the manner in which the sliced piece of food exits the machine, usually falling by gravity, can sometimes lead to folds and bends in the sliced piece of food or slice. This disadvantage is aggravated by the thinner the slices.

There thus remains a need for a food slicing machine or device which is effective in slicing any type of product and which, at the same time, is simple.

### SUMMARY

The present food slicer has a very simple configuration with which the drawbacks of the food slicers known hitherto are mitigated. With the food slicer described below, it is possible to slice almost any type of food product in a very effective way. As it will be seen hereinafter, the present food slicer further provides additional advantages over slicers known hitherto, from which users and consumers especially will benefit.

For the development of the present slicer, in addition to the study of many other foods with different characteristics, products with high requirements for their slicing such as, for example, Iberian acorn-fed ham, having a fibrillar structure, have been taken into account. This is a food product of high quality that is given by different fatty acids, both visible and micro-filtered, that melt from 18° C. This particular food product must therefore be sliced into very thin sheets, even thinner than 1 millimetre and always in the fiber or grain direction, so as to be tasted in at the time following its separation from the whole piece or virgin block. With the slice that is described below, it is possible to slice this product without producing heat due to friction so that valuable fats do not melt or burn. In this way, the product can be offered in small format sheets, not exceeding the size of the tongue, so that all the aromas are released when tasted. Thus, with the slicer described below, the work of the very renowned Iberian ham slicers is the same and even better without the need for purchasing a whole piece of heavy weight, of the order of 8 kg which, once opened, must be consumed in a few days.

The present food slicer has a modular configuration consisting of at least one first support module, a second support module and a driving mechanism for the movement of the support modules. As used herein, the modular character of the present food slicer mechanism that the parts thereof, each with a defined function, are independent of each other, that is, they can be removed from the slicer and replaced by others. This allows a great freedom of choice of materials and physical and/or geometrical characteristics for each of the parts or modules of the slicer, thus optimizing its construction and operation. In addition, the modules of the present slicer can be interchanged with other modules of other machines. This advantageously allows making modifications, improvements, updates or specific developments for different requirements.

The first support module of the slicer is configured to support at least one slicing blade suitable for slicing a piece of food, such as ham, etc., into slices. The slicing blade may be configured as a disc having a diameter ranging from 60 to 150 millimetres, which has been found to be a suitable dimensional range such than an optimal slice of a food, such as ham, is obtained without affecting its characteristics. As an example, for a high-quality Iberian ham, it is advantageous to use a blade with a diameter within this range in order to obtain slices not larger than the size of the tongue, i.e. approximately 70×50 mm. Other sizes are however possible according to the characteristics of the piece to be sliced.

On the other hand, the second support module is configured to support at least one piece of food to be sliced. Said second support module serves the purpose of holding the food during slicing and advancing it properly towards the blade to pass out through an outlet opening, which will be described in more detail further below, after each slice has been performed.

The support modules can be moved relative to one another.

As stated above, the present food slicer includes a drive mechanism. Said drive mechanism is configured to transform the relative movement of the first and second support modules into a movement of the slicing blade in the first support module where it is mounted. That is to say, through such drive mechanism, as the support modules move relative to one another, during the operation of the food slicer, the slicing blade is moved, for example, rotated, in the first support module, to perform slicing of the piece of food. In a particular case, a displacement of the second support module towards the first support module is transformed into a movement of the slicing blade by the drive mechanism, such as for example in rotation. The speed of the slicing blade, for example a speed of rotation, is of a predetermined magnitude, proportional to the relative movement of the first and second support modules. It is usually preferred that the slicing blade is driven in rotation although, as stated above, it could be displaced, it could be fixedly mounted on a movable support, etc.

In one example, the rotational speed of the slicing blade is proportional to the linear travel speed of the first support module relative to the second support module. In this way, the speed of rotation of the blade can be properly adjusted by the user through the travel speed of the piece of food to be sliced. The energy required to rotate the slicing blade therefore comes from the movement itself performed by the user on the first support module to move it relative to the second support module. The drive mechanism of the slicer may comprises gears, such as toothed gearings, toothed wheels, sprockets, and/or pulleys, toothed belts, shafts, racks, etc. The drive mechanism of the slicer may be configured to select a suitable ratio of the rotation speed of the slicing blade to the relative displacement of the support modules. Such relationship of the travel movement of the support modules to the rotational movement of the slicing blade takes into account the characteristics of the food to be sliced so as to contain frictional heat generated in slicing.

It is preferred that the drive mechanism is configured to rotate the slicing blade as the first support module is moved toward the second support module but not to drive the slicing blade as the first support module is moved back away from the second support module. Thanks to this feature, detachment of sliced food from the blade is promoted and friction on the still not sliced food by unnecessary rotation is avoided.

A biasing member such as, for example, a compression spring, that oppose the travel movement of the first support module in a direction towards the second support module may be provided. That is, if a compression spring is provided, in operation, the first support module is moved towards the second support module by the user against the biasing action of said spring and, once the slicing has been performed, the first support module is pushed by the spring away from the second support module.

The relative movement of the support modules can be performed manually or it may be motor driven. If the relative movement of the support modules is manual, said movement is performed by direct manual pushing, such as, for example, through a hinged lever and/or by directly pushing downwards the first support module towards the second support module. If a hinged lever is provided, it can be hingedly mounted on the first support module and it can be removed in order to facilitate transportation and storage. The hinged lever is associated with said drive mechanism to cause relative movement of the first and second support modules. Thus, actuation of the lever causes the first support module and the second support module to be moved towards each other and, simultaneously, the slicing blade to be rotated.

Preferably, the hinged lever is mounted such that, in order to perform slicing, it has to be pushed down by the user. In such a case, a predominantly vertical force is produced, perpendicular to the supporting surface of the food, particularly at the time when the slicing blade fully enters the piece of food and the force reaches its maximum value. While there may also be horizontal components of the force upon actuation of the hinged lever, which are substantially parallel to the food supporting surface, they are balanced by friction between the base of the food slicer and the food supporting surface in the second support module.

The arrangement of the slicing blade in the first support module to be driven to perform slicing downwardly provides an important advantage over conventional slicers with horizontal travel of food. In the present slicer, the sliced piece of food, that is, the slice or sheet, tends to rotate downwardly, when exiting the slicer, about an imaginary horizontal axis, so that the effects of gravity are combined with the effect of the natural detachment of the slice from the piece of food from which it is detached, which is beneficial for an effective and smooth slicing.

The hinged lever of the present slicer can also be modular in nature. Therefore, the hinged lever can be removed and exchanged for another one, so as to update its shape for another type of food to be sliced, to replace it in repair operations or to remove it for maintenance operations. For example, the hinged lever may be a linear bar, but it could be removable to mount an L-shaped hinged lever so as to ensure the vertical direction of the force to be applied in the slicing operation, for example, or to mount a lever configured as a crank lever, whose rotation causes the slicing blade to be rotated while the first support module and the second support module are moved towards each other.

Although it has been described that the hinged lever can be mounted to rotate by manually pushing it downwards, that is, laterally in a vertical plane coincident with the plane of the slicing blade, about a substantially horizontal axis, in other possible examples, the hinged lever can be mounted to rotate forward, also about a substantially horizontal axis, moving towards or away from the food support plane.

Advantageously, the provision of a hinged lever allows a large force to be applied in the slicing with reduced effort. As stated above, the user may alternatively or additionally push the first support module directly by pressing downwardly against the food to perform slicing or for assisting it. Thus, when performing the slicing, the weight of the first support module allows reducing the force to be applied.

If the relative movement of the support modules is motor driven, a suitable motor device, such as an electric motor, are provided so as to cause the relative movement of the first and second support modules. Also, in this case, the motor device operate in conjunction with the drive mechanism, so that when they cause the support modules to move relative to one another, the slicing blade is moved, for example, rotated, in the first support module, to perform slicing of the piece of food.

In any case, whether the relative movement of the support modules is manual or motor driven, there is a combined displacement action of the blade first support module with the rotation thereof to cause the slicing of the food.

Particular account should be taken of the fact that the relative movement of the first and second support modules involves a variation in the height between the two support modules. In a possible configuration of the present food slicer, a support module may be placed vertically on the other support module, so that their relative movement results in a variation in the height therebetween. Other configurations such as, for example, a diagonal arrangement of both support modules, are not ruled out. In general, any embodiment is envisaged where the first and second support modules are at different levels relative to each other to the horizontal, irrespective of the angle between them.

In the present food slicer, the slicing blade has a very advantageous configuration, with which it has been found that an optimal slice of the food is obtained. In particular, according to an important feature of the present food slicer, the slicing blade has a protruding portion projecting from at least one surface of the slicing blade according to at least one inclined plane or ramp. This inclined plane or ramp of the protruding portion of the slicing blade may be arranged oriented so as to facilitate removing of the sliced piece of food from the slicing blade, thus avoiding unwanted stress with the remainder of the piece of food which could damage the sliced piece of food. In one example, the protruding portion may have two inclined planes or ramps, one arranged in a lower part of the slicer and another arranged in an upper part of the slicer. The inclined planes or ramps converge at an edge facing out of the slicer to push the sliced portion of the food out of the slicer. Both inclined planes or ramps may have a different slope. Thus, for example, the inclined plane or ramp arranged in a lower part of the slicer may have a slope less than the inclined plane or ramp arranged in an upper part of the slicer. In any case, the protruding portion of the slicing blade may be formed integral therewith or it may be a separate part coupled thereto in any suitable manner.

The geometry of the ramps may vary and, within their definition as an inclined or sloping plane, they are understood as to include any type of flat and/or curved inclined surface, whether it is concave and/or convex, corrugated, irregular, etc. The ramp pushing edge, that is, the ramp outer edge, could be slightly curved. These variations in the geometry of the ramps allow an appropriate configuration to be selected so as to obtain an optimum detachment of the sliced piece of food.

The present food slicer may comprise a slicing end of run stop that is adapted to separate the food to be sliced from the slicing blade an adjustable distance in order to predetermine a thickness of the sliced piece of food, such as a slice, according to the needs. This therefore allows to provide sliced pieces of food of different thicknesses.

As stated above, the present food slicer has a modular configuration that includes a first support module, a second support module and other parts, such as a hinged lever for moving them. It may be advantageous that said slicing end of run stop is also part of such modular configuration and that it is therefore a part that is separate and detachable from the slicer for repair or maintenance operations or for replacing it with a different slicing end of run stop.

In the present food slicer, an outlet opening is provided, that will be described below, located in correspondence with the slicing blade. The outlet opening is configured to facilitate the exit of the sliced food. The outlet opening of the slicer may also contain an adjustable slicing end of run stop to set the thickness of the slices of product to be obtained. For this purpose, it may be possible to vary the distance between the plane of the slicing end of run stop and the plane of the slicing blade, which are generally parallel to each other, so as to change the thickness of the sliced food and to obtain a sliced piece of food according to the needs.

The outlet opening, in one example, defines an empty portion in the first support module to facilitate moving of the piece of food being sliced out of the slicer. The geometry of the outlet opening may be shaped in the body constituting said first support module or it may be constituted by an empty portion suitable for housing different elements or modules. This allows one outlet opening to be exchanged with a different outlet opening depending on the characteristics and the shape of the food to be sliced. In this way, a very versatile slicer is obtained, which can be used for products with very different characteristics of hardness, unctuousness, etc.

In some variants of the present food slicer, a pushing member adapted to push the piece of food to be sliced against the slicing blade. The pushing member may for example be formed of a vertical plate that can be moved on a plane that is substantially perpendicular to the slicing so as to advance the food to be sliced against the slicing blade. The pushing member can also be of modular nature. Thus, different types of pushing members may be provided for different product types and/or formats.

The pushing member may be mounted on the second support module such that it can be moved. For this purpose, a guide member associated with the second support module may be provided to guide the movement of the pushing member thereon. In some variants, a mechanism for automatically driving the pushing member causing it to advance a distance equivalent to the thickness of the sliced piece of food may be provided.

A strap associated with the pushing member, configured to hold a piece of food to be sliced pressed against the slicing end of run stop may be also provided.

On the other hand, the pushing member may be located in a number of different adjustable positions relative to the slicing blade so as to change the position of the food as it moves towards the blade and out of the slicer, according to its characteristics, such as unctuousness, consistency, thickness. For example, if the sliced food must exit the slicer according to a substantially horizontal movement, the pushing member must be placed in the second support module so that the food to be sliced is located in a centred position. If, because of its characteristics, it is preferred for the sliced food to exit the slicer according to a substantially upward movement, the pushing member must be placed in the second support module so that the food to be sliced is slightly shifted to one side with respect to the slicing blade.

For collecting the sliced pieces of food, a lower collecting tray may be provided, which may be also modular, that is, independent of other parts of the slicer and detachable therefrom. The lower collecting tray may be received in the bottom of the second support module and may be configured to receive and house the food to be sliced therein under optimal conditions.

In some variants of the slicer, it may include an automatic driving mechanism for advancing the lower collecting tray. This automatic driving mechanism may be suitably configured to move the lower collecting tray horizontally a predetermined distance from the first support module in each slicing operation, i.e., each time the slicing blade is moved toward the second support module. Thus, in operation, the sliced pieces of food are deposited overlapping each other on the lower collecting tray but displaced by said predetermined distance away from each other.

In one example, the second support module may contain a plane for supporting the product to be sliced at a given height. This plane may be configured on an inner housing or box where oxygen absorbing envelopes, one or more valves allowing air to escape, but preventing it to enter, or equivalent systems, etc. may be provided for temporarily preserving already sliced food, or food to be sliced, in optimal conditions. The second module may also be configured to be removed from the slicer, when it is not used, for storage in a refrigerator, for example.

The operation of the slicer that has been described is extremely simple. A food, for example a piece of ham, is placed by the user on the second support module, and the pushing member is pushed with one hand. This causes the food to be sliced to travel in the second support module towards the first support module and, therefore, towards the slicing blade. The hinged lever is rotated downwards by the other user's hand, causing a vertical downward movement of the first support module and, at the same time, rotation of the slicing blade. As stated above, the vertical lowering movement of the first support module relative to the second support module can alternatively be carried out by directly pushing the first support module downwards without the use of the hinged lever or by combining the pushing action on the hinged lever with the pushing action on the first support module downwards. In any case, as the first support module, with the slicing blade, moves towards the second support module and the slicing blade contacts the food, the food is sliced. The formed slice exits through the outlet opening at the back of the slicer, to be collected or dropped on the lower collecting tray.

Once the slicing of the food has been performed, that is, once a slice has produced, the first support module is biased upwards away from the second support module to an initial rest position by the above mentioned biasing member formed, for example, of at least one compression spring. During such return operation of the first support module, the slicing blade can be disengaged from the drive mechanism, as described previously.

The above described slicer can be advantageously applied for foods with very different physical and structural characteristics in terms of homogeneity, unctuousness, fibrillary structure, hardness, melting temperature, etc. With the configuration of the slicer that has been described, the advantages of the traditional knife slicing operations, currently highly valued, are retained, relating to avoiding transfer of heat to the product, preserving the flavours characterizing this product, in combination with its hardness, density and fibrousness. With the slicer that has been described, a further advantage is obtained that slicing of the food, for example a piece of ham or the like, is made simple, being a very easy, comfortable and efficient operation, requiring very little manual effort on the part of the user when the slicer is manually operated, for example, through the hinged lever, as described above. In such a case, furthermore, no electrical supply or other type of energy is required other than the force applied by the user, which is less than the effort required in the case of employing a knife to perform the same function.

In addition, the present slicer has a very simple and precise structural and mechanical configuration, which allows slicing a food into slices or sheets with a constant but adjustable thickness without the need for any special skill on the part of the user.

A further advantage deriving from the configuration of the present slicer is that it is very respectful of the conditions required by foods like Iberian ham, and slicing does not adversely affect its characteristics of homogeneity, unctuousness, fibrillary structure, etc. as with other conventional mechanisms or machines. As with slicing with a knife, the slicing speed of the present slicer can be suitably adjusted by the user without increasing the temperature of the piece of food to be sliced, which is much appreciated by professionals and consumers. It has thus been found that the configuration of the present slicer is very suitable for foods especially sensitive to striking and heat, such as the Iberian ham.

The mechanical simplicity of the described configuration of the slicer makes it very economical, and also very light in weight. The reduced weight of the slicer allows it to be carried and handled with very little effort by a person in the domestic environment or that of the catering. Furthermore, the assembly is shown to be very stable in operation, not requiring to be attached to a working surface or to be hand held during slicing, since, in operation, the slicer is subjected to a force essentially comprising a component that is perpendicular to the working surface.

In addition to the above, the modular nature of the described slicer, with mutually independent modules, allows a great freedom in the choice of materials and/or physical and/or geometric characteristics for each of the parts or modules of the slicer, optimizing its construction and handling. In addition, the modules constituting the present slicer can be interchanged with other modules of other machines. This advantageously allows to extend, make modifications, improvements, or specific developments of the slicer over its useful life for different requirements. The modular nature of the slicer allows upgrades to be made, including new modules improving existing ones at the time of manufacture or that better adapt to new user requirements or including new features, all without the need for specialized personnel. This makes it possible to obtain an extremely versatile slicer, whose design can be flexibly adapted to a large number of specific applications, whether they are of the domestic, commercial, restoration environment, etc., by modifying only one or several of its modules.

The machine thus conceived and its modular character make future developments possible. This allows the consumer to taste, from small pieces that are supplied, foods that come in a virgin or suitable state to be sliced and consumed without loss of their organoleptic qualities and without no more means or knowledge or skill on the part of the user who is slicing food. As non-limiting examples, the present slicer can slice pieces of food in a systematic way in one or several portions in order to obtain slices of 7×5 or 6×6 centimetres with adjustable thickness. Industrialists can supply consumers with high quality, low volume products ready to be sliced from a virgin product and that be consumed without loss of quality against typical slicing systems.

Additional objects, advantages and features of examples of the present food slicer will become apparent to those skilled in the art upon examination of the description, or may be learned by practice thereof.

### BRIEF DESCRIPTION OF THE DRAWINGS

A particular example will now be described of the present food slicer by way of a non-limiting example, with reference to the accompanying drawings.

In the drawings:

FIG. 1 is a perspective view of one example of the present food slicer from a front part, shown in an initial rest position, with the hinged lever raised;

FIG. 2 is a perspective view of the example of the food slicer in FIG. 1, from a rear part;

FIG. 3 is a perspective view of the example of the food slicer of FIGS. 1 and 2, from a bottom rear part;

FIG. 4 is a perspective view of a slicing blade used in the present food slicer;

FIG. 5 is an elevational sectional view of the slicing blade of FIG. 4 taken along line AA′ in FIG. 6;

FIG. 6 is a plan view of the slicing blade of FIGS. 4 and 5;

FIG. 7 is an enlarged fragmentary side elevational view of the slicing blade in

FIG. 5, with the blade being shown slicing a food into a slice; and

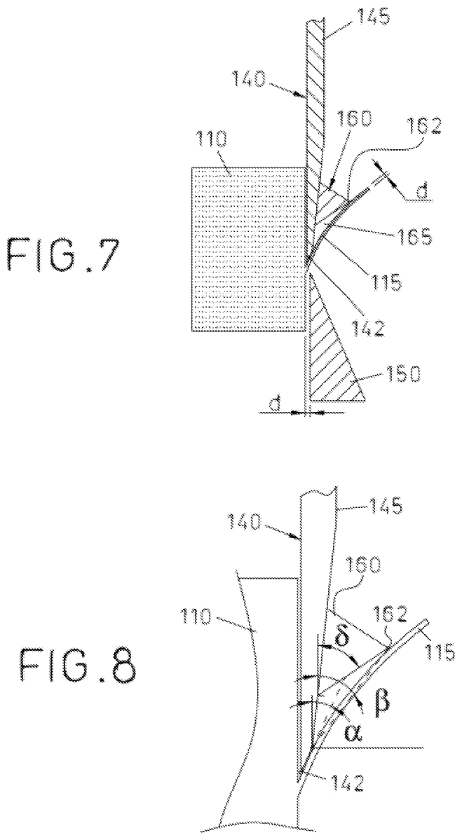

FIG. 8 is a diagrammatic view of the blade in the position of FIG. 7 slicing a food, with parameters defining the geometry of the slicing blade being shown

### DETAILED DESCRIPTION OF A PREFERRED EXAMPLE

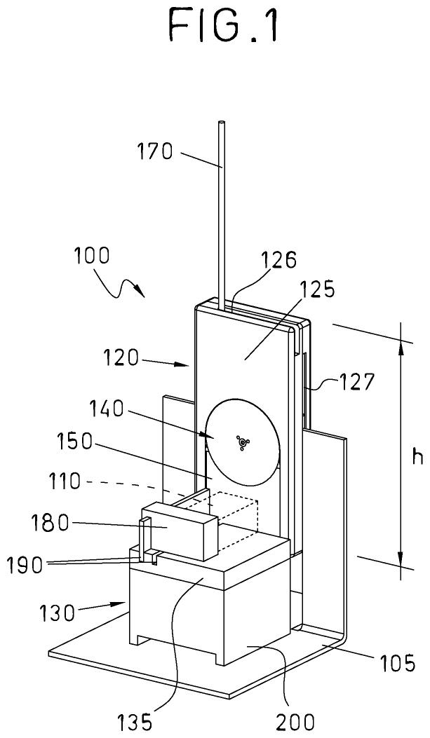

A non-limiting example of a food slicer, which has been designated as a whole by reference numeral 100 in FIGS. 1-8 of the drawings is described below. In the drawings, the piece of food to be sliced by the present slicer 100 has been designated by 110, while the sliced piece of food, such as a slice or sheet, has been designated by 115. The piece of food to be sliced 110 by the present slicer 100 may be ham, such as, for example, Iberian ham, or any other food having physical and structural characteristics similar or different in terms of homogeneity, unctuousness, fibrillary structure, hardness, melting temperature, etc.

In the non-limiting example illustrated in said FIGS. 1-8 of the drawings, the food slicer 100 comprises a base structure 105 or fixed frame where a series of modular elements, interchangeable and removable from each other and from the base structure or fixed frame 105 are directly or indirectly mounted. The modular nature of the food slicer 100 described herein allows the slicer 100 to be configured in a very flexible manner so as to accommodate a wide variety of applications and uses. The modular elements can be interchanged with modular elements of other machines, which allows to expand the slicer and make modifications, improvements, updates or specific developments of the slicer 100 throughout its useful life for different requirements.

Among the modular elements forming the food slicer 100 a first support module 120, a second support module 130 and drive mechanism, not shown, are provided.

The first support module 120 of the food slicer 100 comprises a plate-like support body 125 that is configured to support a slicing blade 140. An upper groove 126 is formed in the support body 125, suitable for housing a hinged lever 170, which will be described in detail further below, and lateral guides 127 for guiding the movement of the first support module 120, as it will be described in detail further below.

The slicing blade 140 is a circular disc that is rotatably mounted on the support body 125 of the first support module 120. The slicing blade 140 has a diameter in the range from 60 to 150 millimetres, for example 86 millimetres, which has been found to be the most suitable for slicing foods such as Iberian ham. Further dimensions for the slicing blade 140 are possible.

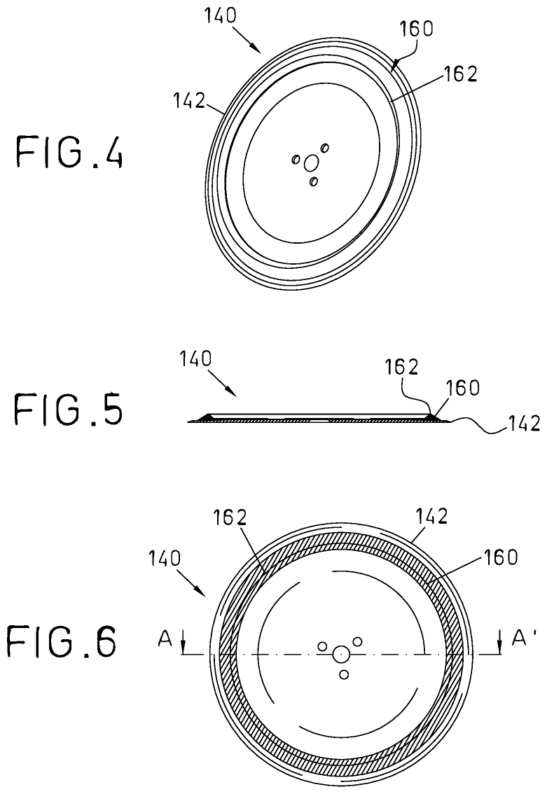

Referring now to FIGS. 4-8 of the drawings, the slicing blade 140 has a sharp edge 142 and a protruding portion 160 formed near said sharp edge 142 and protruding from the outer surface 145 of the slicing blade 140 forming a protruding ring projecting out of the slicer 100 in the direction to the outlet of the sliced piece of food 115.

The protruding portion 160 of the slicing blade 140 is shown enlarged in detail in FIG. 7 of the drawings. In the example shown in FIG. 7, said protruding portion 160 is shown as a separate part from the slicing blade 140, but it could be an integral part with the slicing blade 140. In any case, said protruding portion 160 is formed by two inclined planes or ramps which are suitably facing towards the outlet of the sliced piece of food 115. More specifically, in the example shown in the figures, the protruding portion 160 is formed by one ramp that is arranged in a lower part and another ramp that is arranged in an upper part of the slicer 100. Both ramps converge in a pushing edge 162 facing away from the slicer 100 and whose function is to push the sliced piece of food 115 towards the exterior of the slicer 100 during the slicing operation.

It should be noted that although the ramps that define the protruding portion 160 are illustrated in the exemplary figures formed by flat surfaces, the geometry of said ramp surfaces may be different. In general, the definition of ramp as a body formed by an inclined or sloping plane includes herein any kind of flat and/or curved inclined surface, whether it is concave and/or convex, corrugated, irregular, etc., or combinations thereof. On the other hand, the pushing edge 162 may be slightly curved. These possible configurations of the protruding portion 160 allow an appropriate configuration to be selected to obtain an optimal detachment the sliced piece of food 115.

The ramps, in the example shown, have a different slope, so that the ramp of the lower part has a slope that is less than that of the ramp provided at the upper part. Said ramps or inclined planes of the protruding portion 160 of the slicing blade 140 define an empty space 165. Such empty space 165 is suitable to prevent the sliced piece of food 115, that is, the slice or sheet, from being adhered to the outer surface 145 of the slicing blade 140.

FIG. 8 schematically shows the slicing blade 140 when a piece of food 110 is being sliced by the slicer 100. Some parameters defining the geometry of the slicing blade 140 are shown in said FIG. 8. Reference numeral 115 in FIGS. 7 and 8 illustrates the arc defined by the sliced piece of food 115. In order to obtain such output inclination of the sliced piece of food 115 with an effective slicing preventing the sliced piece of food 115 from adhering to the slicing blade 140, it is preferred to set certain angles α, β and δ relative to the vertical, wherein:

α is the angle of attack of the slicing blade 140, and therefore the output starting angle of the food;

β is the angle of the imaginary line between the sharp edge 142 and the pushing edge 162 defining the output path for the sliced piece of food 115; and

δ is the angle defining the ramp of the protruding portion 160, from the slicing blade 140 to the pushing edge 162.

Given these parameters, it is appropriate that the following relationships are met:

β>α;

δ>β; and

(δ−β)>(β−α).

so that the sliced piece of food 115 defines a natural output arch taking advantage of the angle of attack of the slicing blade 140 but preventing the sliced piece of food 115, through the small air gap formed by the empty space 165, from being adhered upon slicing. Vertical slicing is advantageous since it helps to detach foods such as Iberian ham sliced into slim sheets from the slicing blade 140 since slicing is performed with the fibres of the food arranged in a vertical position.

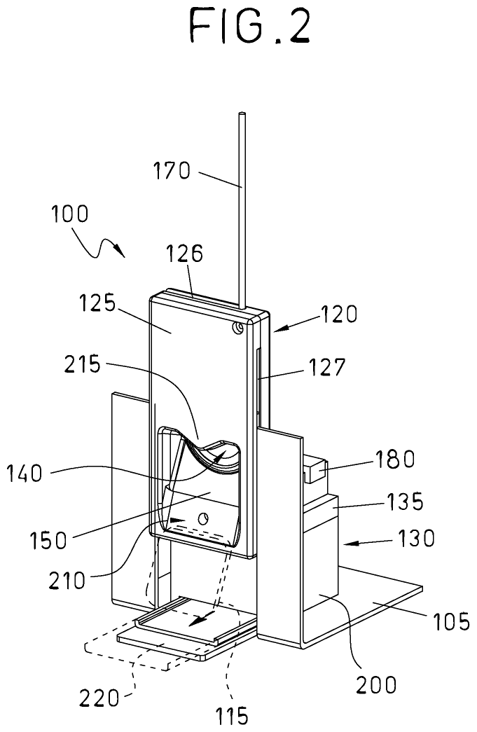

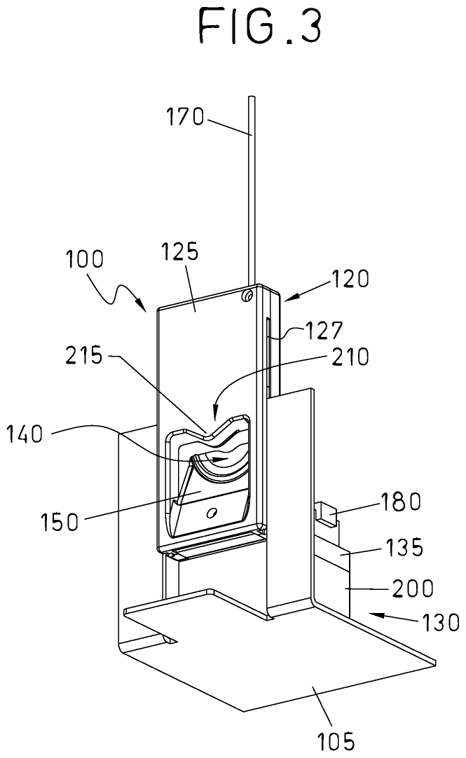

Turning to FIGS. 1 to 3 of the drawings, the second support module 130 comprises a housing of box 200 and an upper surface 135. The upper surface 135 is configured to slidably support a pushing member 180, which will be described in detail further below, intended to hold and advance the piece of food to be sliced 110 towards the slicing blade 140 to perform slicing and to cause the sliced piece of food 115 to pass through an outlet 210, which is located in correspondence with the slicing blade 140, as shown in FIGS. 2 and 3, which is described further below.

The outlet opening 210 is an empty portion of the first support module 120 that may contain the slicing end of run stop 150 so as to set the thickness of food slices 115, as indicated in FIG. 7 by reference d. In said outlet 210 a protrusion 215 is provided in the illustrated example that is suitable to facilitate the exit of the sliced food 115 out of the slicer 100.

The first support module 120 can be moved vertically along the base structure 105 of the slicer 100, along the above mentioned side guides 127 of the support body 125 to move towards and away from the second support module 130 during operation of the slicer 100.

In the non-limiting example herein described, the relative movement of the support modules 120, 130 is performed manually by the above-mentioned hinged lever 170, which will be now described in detail.

The hinged lever 170 is a bar that is detachably mounted on the first support module 120 so that it can be rotated relative thereto laterally in a substantially vertical plane coincident with the plane of the slicing blade 140, about a substantially horizontal axis. Other configurations and shapes of the hinged lever 170 are possible.

The manual operation of the hinged lever 170 downwards causes the first support module 120 to move towards the second support module 130 and, at the same time, rotation of the slicing blade 140 in the first support module 120.

To perform simultaneous movement of displacement of the first support module 120 towards the second support module 130 and the rotational movement of the slicing blade 140, the above mentioned drive mechanism, not shown in the figures, are used. The drive mechanism comprises gears which are configured and arranged to transform the manual rotation of the hinged lever 170 into a combined driving of displacement of the first support module 120 downwards towards the second bearing module 130 and simultaneous rotation of the slicing blade 140 at a rotational speed as a function of the characteristics of the piece of food to be sliced 110. The hinged lever 170 is associated at one end thereof with an input gear of the drive mechanism, so that, when the hinged lever 170 is rotated by the user downwardly against the action of the spring, not shown, the first support module 120 is moved downwardly toward the second support module 130 while the slicing blade 140 is rotated, slicing the food 110 properly into slices 115 passing through the outlet opening 210.

As shown in FIGS. 1-3 of the drawings, the food slicer 100 operates vertically. That is, the first support module 120 is disposed vertically on second support module 130 and, in operation, the first support module 120 is vertically movable relative to the second support module 130 resulting in that the vertical height h between them, illustrated in FIG. 1, is changed.

As it can be seen in said FIGS. 1-3 of the drawings, the slicer 100 includes a slicing end of run stop 150. The slicing end of run stop 150 is also modular in nature, that is, it comprises a removable vertical plate that can be interchanged by others. Said vertical plate is sized to separate the food to be sliced 110 from the slicing blade 140 a predetermined distance so as to act as a stop setting a thickness d of the sliced pieces of food 115, shown in FIG. 7 of the drawings. The vertical plate of the slicing end of run stop 150 is movable so as to adjust the separation distance between the food to be sliced 110 and the slicing blade 140 and thus to set the desired thickness d of the sliced pieces of food 115.

In order to push the part of food to be sliced 110 against the slicing blade 140 a pushing member 180 is provided. The pushing member 180 is also modular and detachable from the slicer 100, so that different types of pushing members 180 can be mounted for different types and/or formats of foods to be sliced 110. In the example shown, the pushing member 180 comprises a vertical plate adapted to move horizontally in the second support module 130, that is, in a plane substantially perpendicular to the slicing operation and to cause a forward movement of the food to be sliced 110 towards the slicing blade 140. Suitably sized guides 190 are provided on the upper surface 135 of the second support module 130 to guide the movement of the pushing member 190 toward or away from the slicing blade 140.

The guides 190 do not only serve the purpose of better centring the sliced pieces of food 115 according to their thickness. In particular, when pieces of Iberian ham are desired to be sliced, especially in very thin sheets 115, they tend to bend as they turn by gravity, and even to split into two or more portions if it is a very sensitive or veined product, as in the case of the Iberian ham and others. In order to avoid this problem, the part of food to be sliced 110 has to be placed with its fibres oriented vertically, so that the output of the sliced pieces of food 115 can be suitably carried out.

In a further example, the pushing member 180 could run on a tunnel-like structure, defined by the surface 135 of the second support module 130 and an upper surface, not shown, parallel thereto, which would also be provided with own guides, in addition to guides 190 of said surface 135 of the second support module 130.

As discussed above, a lower collecting tray 220 is provided in the second support module 130. The lower collecting tray 220 is configured to collect sliced pieces of food 115, such as slices or sheets. Through an appropriate mechanism, not shown, the lower collecting tray 220 can be moved away from the slicing blade 140 a predetermined distance each time the first support module 120 moves towards the second support module 130, that is, each time a slicing operation is performed. Thus, as the piece of food 110 is sliced, the sliced pieces of food 115 are deposited on top of each other in the lower collecting tray 220 and offset from one another by said predetermined distance. The lower collecting tray 220 may be removable from the second support module 130.

The mode of use of the food slicer 100 will be described herein below. The user first places a food such as, for example, a piece of ham 110, on the upper surface 135 of the second support module 130. Once the piece of ham 110 is placed, the user pushes horizontally with one hand the plate of the pushing member 180 so that the piece of ham 110 is moved horizontally toward the slicing blade 140. Once the piece of ham 110 is disposed under the slicing blade 140, the user with the other hand rotates the hinged lever 170 downwardly against the force of an elastic member, not shown. Rotation of the hinged lever 170 causes the first support module 120 to move, together with the slicing blade 140, vertically downwards, toward the second support module 130 and simultaneously rotation of the slicing blade 140, causing the piece of ham 110 to be sliced into a slice 115.

Once the piece of ham 110 has been sliced, the first support module 120 is pushed upwardly by the biasing member, along with the slicing blade 140, away from the second support module 130 to the initial rest position shown in FIGS. 1-3 of the drawings. In the described example, the slicing blade 140 is disconnected from the drive mechanism during said return operation of the first support module 120 to the initial rest position. That is, during vertical upward displacement of the first support module 120, away from the second support module 130, the slicing blade 140 is not driven in rotation.

This slicing operation can be repeated several times to obtain the slices 115 which are deposited on said lower collecting tray 220, illustrated by way of an example in FIG. 2, superimposed and displaced away from one another, being ready for storage, distribution, or otherwise directly for consumption, perfectly presented. The collecting tray 220 may be arranged at the bottom of the lower housing 200, for example.

Although only a number of particular examples have been disclosed herein, it will be understood by those skilled in the art that other alternative examples and/or uses and obvious modifications and equivalents thereof are possible.

The present disclosure covers all possible combinations of the particular examples described. The scope of the present disclosure should not be limited to such examples but should be determined only by a fair reading of the claims that follow.

Reference signs related to drawings and placed in parentheses in a claim, are solely for attempting to increase the intelligibility of the claim, and shall not be construed as limiting the scope of the claim.

1. A food slicer comprising:
a first support module for supporting at least one slicing blade,
a second support module for supporting at least one piece of food;
and
a drive mechanism for transforming a relative movement of the first and second support modules into a movement of the slicing blade in the first support module, said relative movement involving a variation of the height between the first and second support modules,
wherein the slicing blade has a protruding portion protruding from at least one surface of the slicing blade according to at least one ramp oriented to facilitate the separation of a sliced piece of food from a rest of the piece of food without damaging it.

2. The food slicer according to claim 1, wherein the protruding portion is integral with the slicing blade.

3. The food slicer according to claim 1, wherein the food slicer additionally comprises a slicing end of run stop adjustable to set a thickness of sliced pieces of food.

4. The food slicer according to claim 3, wherein the at least one of the first support module, the second support module, or the slicing end of run stop is independent and detachable from the slicer.

5. The food slicer according to claim 1, wherein he food slicer additionally comprises a hinged lever associated with the drive mechanism for causing relative movement of the first and second support modules.

6. The food slicer according to claim 1, wherein the food slicer additionally comprises a motor device for causing relative movement of the first and second support modules.

7. The food slicer according to claim 1, wherein the drive mechanism is configured for driving the slicing blade as the first support module is moved towards the second support module, and not driving the slicing blade as the first support module is moved away from the second support module.

8. The food slicer according to claim 1, wherein the food slicer additionally comprises a biasing member arranged to oppose the movement of displacement of the first support module in a direction towards the second support module.

9. The food slicer according to claim 1, wherein the food slicer additionally comprises a pushing member for pushing the piece of food against the slicing blade.

10. The food slicer according to claim 9, wherein the food slicer additionally comprises a guide member associated with the second support module for guiding the movement of the pushing member.

11. The food slicer according to claim 9, wherein the pushing member includes a strap configured to hold the piece of food pressed against a slicing end of run stop.

12. The food slicer according to claim 9, wherein the food slicer additionally comprises a mechanism for automatically driving the pushing member for advancing the pushing member a distance equivalent to the thickness of the sliced piece of food.

13. The food slicer according to claim 1, wherein the slicing blade is configured as a disc having a diameter ranging from 60 to 150 millimetres.

14. The food slicer according to claim 1, wherein the food slicer additionally comprises a lower collecting tray configured for collecting sliced pieces of food.

15. The food slicer according to claim 14, wherein the lower collecting tray is movable away from the first support module a predetermined distance each time the slicing blade is moved relative to the second support module so that the sliced pieces of food are deposited on each other in said lower collecting tray offset from each other by said corresponding distance.
